(19) United States
(12) Patent Application Publication
(10) Pub. No.: US 2010/0105016 A1
(43) Pub. Date: Apr. 29, 2010

(54) Format for presenting a story and method of use

(76) Inventor: Thomas J. Margolis, Boulder, CO (US)

Correspondence Address: TED MASTERS;TED MASTERS & ASSOCIATES, INC., 5121 SPICEWOOD DRIVE, CHARLOTTE, NC, 28227-0313, US

(21) Appl. No.: 12/215,106

(22) Filed: Jun. 25, 2008

(51) Int. Cl. G09B 17/00

(52) U.S. Cl. 434/178

(57) ABSTRACT

A format for presenting a story includes page stations which contain first and second narratives, the second narrative being written at a higher reading level than the first narrative. Both narratives convey the same thought but do so using different words, phases, concepts, and/or sentence structure. The page also contains an image which depicts the contents of the two narratives. The image connects the two narratives, and can therefore be used as a key to decode unknown words and phrases in the narratives.

### TECHNICAL FIELD

The present invention pertains generally to multi-page documents such as books, and more particularly to a document format for presenting a story.

### BACKGROUND OF THE INVENTION

Children's books are often flagged with a reading-level indicator on the cover and spine—Level One, Level Two, and so forth. The entire book is written at the indicated reading level, and if a different reading level is desired, a different book must be purchased.

### BRIEF SUMMARY OF THE INVENTION

The present invention is directed to a document format for presenting a story in which the same story is presented at two different reading levels. For instance, a simple version of a portion of the story is printed above an image on each page, and a more advanced version of the same story is printed below the image. This format allow readers to explore different reading levels on their own, without external help. It also provides publishers an inexpensive way to publish multiple parallel stories. The present invention allows readers to experience different versions of a story in a single publication. The present invention provides textual and visual cues that readers with a range of skills can use to explore challenging text, at their own pace and level, without external help. The present invention also reduces costs for publishers and consumers, by allowing multiple parallel stories to be published using about the same resources—about the same number of pages and illustrations—as are needed for just one story.

### Features of the Present Invention

Parallel Stories with Non-Verbal Links Between them

Without the present invention, a story collection could present two versions of a story: for example, a simple version on pages 1-50, and an advanced version on pages 51-100. But if a reader of the simple version wanted to explore an interesting part in the advanced version—the part about the sleeping goblin, for instance—the reader would have to read through and comprehend the advanced version to find the part about the sleeping goblin. Or the reader would be forced to get external help.

The present invention presents different story versions in parallel, one part at a time. At any point in a story, a reader can instantly find the matching part of a parallel version, without needing to read and understand the parallel version. This allows a low-level reader, for instance, to explore advanced text at a desired pace, one part at a time. If the reader wants to explore the advanced text about the sleeping goblin, the reader can find it immediately, even if the harder text is not fully understood. Each part of one version is linked with the matching part of another version unambiguously, instantly, and non-verbally. This feature also helps readers of an advanced version instantly find comprehension cues in the simpler version.

### Images Give Cues to the Content of Both Versions

With the present invention, a reader can instantly infer—without any reading—the common content of two different story versions at any point in the story. For instance, an image of a sleeping goblin shows the reader that the simpler and advanced versions on that page both involve a sleeping goblin. The image provides a non-verbal cue that links the content of the text together. Without this unique feature, a low-level reader could only guess what parts of the simple text can be found in the more advanced version, and would be decoding the advanced text without clear cues. The image defines the content shared by the simple and advanced text.

### Efficient Use of Resources

Parallel presentation, with shared images, requires fewer resources to publish multiple stories.

Other features of the present invention include:

This invention defines the format for a single book. The book presents one story through multiple textual versions.
Each textual version tells a complete story, so you can read just one version all the way through without needing to read any of the others.
Every image is obviously linked with one part of text from each version. For instance, a picture of a frightened bird on page 5 obviously belongs with the text above it and below it on that page—but doesn't belong with the text on page 6, which shows a picture of a sleeping goblin.
Each part of a story version is obviously associated with one image. For instance, the text on the top and at the bottom of page 5 obviously belong only with the bird picture on that page. They obviously do not belong with the picture of the sleeping goblin on the next page.
An image is relevant to the content of its text, and vice-versa. For instance, if a page has a picture of a sleeping goblin, the text at the top and bottom of that page will primarily involve a sleeping goblin.
All versions refer to the same events in the same order, and follow the same sequence of images. If there's a frightened bird on page 5 and a sleeping goblin on page 6, each story version will refer to the bird before moving on to the goblin.
An image and all its text can easily be viewed simultaneously. For instance, the picture of a bird and the versions of text that tell about it can all be seen together, without turning pages.

### Advantages

### Reader Independence

The present invention allows the reader to explore challenging text independently. Readers can find the matching text in all versions unambiguously, instantly, and non-verbally. This means low-level readers can find a certain section of advanced text to explore, even if they have trouble reading the advanced story.

Using the same book: A low-level reader can use the images alone to decode the simpler text—just as in traditional illustrated children's books. A reader who is transitioning to a higher level can use the low-level text and the images together to explore the higher-level text. An advanced reader can use the images and lower-level text together to decode challenging passages in the more complex story.

| | Reads: | Uses: | To: |
|---|---|---|---|
| Low-level | Low-level | Image | Decode low-level text |
| reader: | text | | |
| Transitional | Low-level | Image + | Explore advanced text |
| reader: | text | low-level text | |
| Advanced | Advanced | Image + | Decode difficult passages |
| reader: | text | low-level text | |

### Reader Choice

Readers can choose what literacy level they employ while reading. Any version of the text can be read independently of any other versions. At any point in the story, the reader can choose to explore a different version, using the text and image cues provided.

### Economic Efficiency

Because parallel stories share images and pages, the present invention allows multiple stories to be published using fewer resources than traditional means. Some of the savings can be passed to consumers, and some can be kept as profit.

### Uses of the Present Invention

The primary uses for the present invention are for education, for entertainment, and to provide economic benefit to publishers and consumers.

### Educational Uses

A book using the present invention allows readers to explore texts at different literacy levels, at their own pace, without external help.

### Entertainment Uses

Each parallel story can be read on its own: a reader can choose to read only one version of a story and ignore all others. This provides the same entertainment value as standard story books or story collections.

### Economic Benefits

Without the present invention, every published story requires its own set of pages, and possibly its own set of images. This invention lets publishers publish multiple stories using fewer resources: for example, two 50-page stories can be published using 50 pages rather than 100, and using one set of illustrations rather than two. This savings can be passed on to consumers, who can purchase multiple stories at a lower cost than with traditional publishing formats.

In accordance with a preferred embodiment of the invention, a format for presenting a story includes a document having a plurality of page stations. Each page station includes a first narrative written at a first reading level, and a second narrative written at a second reading level, the second reading level higher than the first reading level. Each page station also includes an image, wherein the image depicts both the first narrative and the second narrative.

In accordance with an aspect of the invention, the image depicts narrative content which is shared by the first narrative and the second narrative within the same page station.

In accordance with another aspect of the invention, the image provides a key to content of both the first narrative and the second narrative within the same page station.

In accordance with another aspect of the invention, the first narrative and the second narrative within the same page station present the same part of the story in parallel fashion.

In accordance with another aspect of the invention, the first narrative of all page stations sequentially tell the story, and the second narrative of all page stations sequentially tell the same story.

In accordance with another aspect of the invention, the first narrative, the second narrative, and the image are simultaneously visible within the same page station.

Other aspects of the present invention will become apparent from the following detailed description, taken in conjunction with the accompanying drawings, which illustrate, by way of example, the principles of the invention.

### BRIEF DESCRIPTION OF THE DRAWINGS

FIG. 1 is a top plan view of a format for presenting a story in accordance with the present invention;

FIG. 2 is a top plan view of a second embodiment of the format;

FIG. 3 is a top plan view of the format presenting another story;

FIG. 4 is a top plan view of a document cover; and,

FIG. 5 is a side elevation view of a document spine.

### DETAILED DESCRIPTION OF THE INVENTION

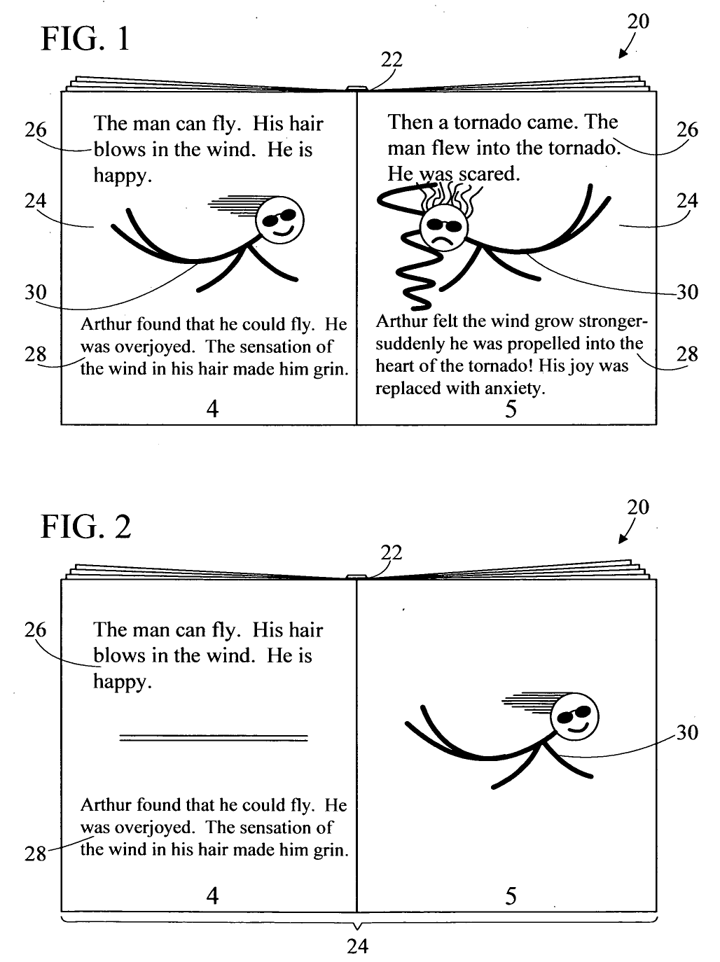

Referring initially to FIG. 1, there is illustrated a top plan view of a format for presenting a story in accordance with the present invention, the format generally designated as 20. Format 20 includes a document 22 having a plurality of page stations 24. As defined herein, a document 22 having a plurality of page stations 24 embraces any multi-page publication such as a book, a pamphlet, a manual, a magazine, a periodical, and the like, and electronically-rendered representations thereof. Also as defined herein, a page station 24 can be either (1) a single side of one page, or (2) facing sides of two adjacent pages. In other words, the entire contents of a page station 24 are simultaneously visible without having to turn a page of document 22. Under definition (1) above, in FIG. 1, page 4 is a page station 24 and page 5 is a different page station 24. Alternately under definition (2) above, in FIG. 2, pages 4 and 5 combine to form a single page station 24 (refer to FIG. 2 and the associated discussion).

Each page station 24 includes a first narrative 26 written at a first reading level, and a second narrative 28 written at a second reading level, the second reading level being higher than the first reading level. For example first narrative 26 could be written at a reading level 1 for children 7 years of age, and second narrative 28 could be written at a reading level 2 for children 8 years of age. The higher the reading level, the more complex are the words, phrases, concepts, and/or sentence structure. As defined herein first 26 and second 28 narratives comprise the textual passages which appear on a single page station 24, and present the same part of the story in parallel fashion. First narrative 26 of all page stations 24 sequentially tell the story, and second narrative 28 of all page stations 24 sequentially tell the same story, but at a higher reading level. That is, the story consists of the sum of the narratives of all page stations 24, wherein each page station 24 presents a part of the story. It is also noted that document 22 can contain other pages which are not a direct part of the story, and as such are not page stations 24 (for example title page, foreword, table of contents, chapter titles, etc.). It is further noted that in the present invention it would be possible to present three or even more narratives, each narrative being written at a different reading level.

Each page station 24 also includes an image 30 which depicts both first narrative 26 and second narrative 28. As defined herein, image 30 is a pictorial element which presents a visual concept: such as a picture, a drawing, a photo, a sketch, a group of these, a pop-up structure, a video clip, a hologram, an electronic rendering, and the like. Image 30 pictorially depicts narrative content which is shared by first narrative 26 and second narrative 28, and as such provides a key to the content of both first narrative 26 and second narrative 28. In the first page station 24 of FIG. 1 (page 4) image 30 shows a flying man, which is described by both first narrative 26 and second narrative 28 of page 4. Similarly in the second page station 24 of FIG. 1 (page 5), image 30 shows a flying man in a tornado, which is described by both first narrative 26 and second narrative 28 of page 5. It is noted that in FIG. 1, first narrative 26, second narrative 28, and image 30 are all disposed on a single side of one page. That is, the page station 24 which is page 4 has all three elements, and similarly the page station 24 which is page 5 has all three elements. Also in this format, image 30 is disposed between first narrative 26 and second narrative 28.

Now turning to FIG. 2, there is illustrated a top plan view of a second embodiment of format 20. In this embodiment, first narrative 26 and second narrative 28 are disposed on a single side of one page (page 4), and image 30 is disposed on a facing side of an adjacent page (page 5). Just as with FIG. 1 however, for a given page station 24 first narrative 26, second narrative 28, and image 30 are simultaneously visible (without having to turn a page of document 22).

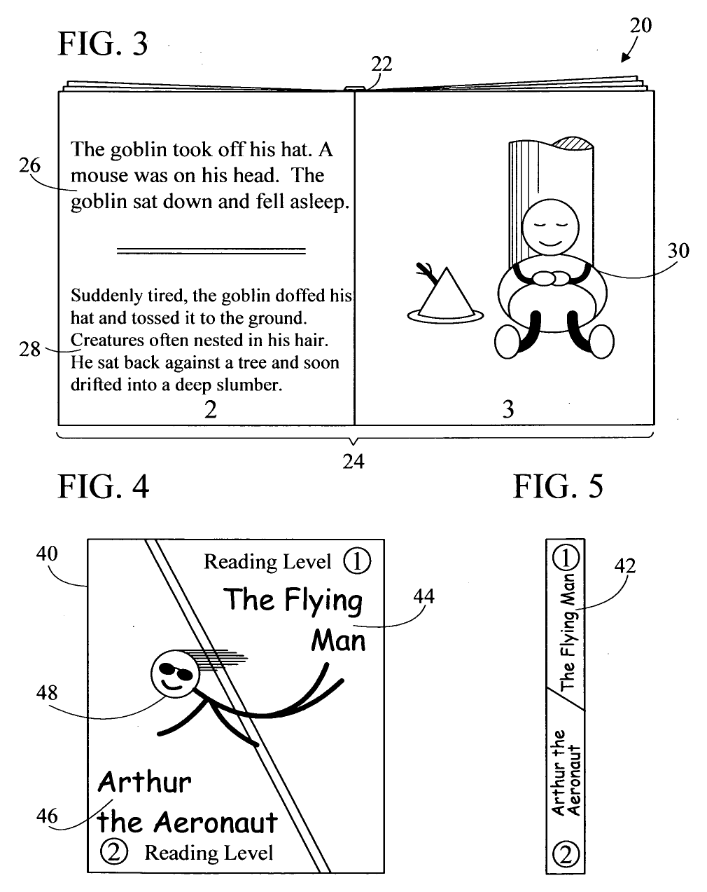

FIG. 3 is a top plan view of format 20 presenting another story, and demonstrates how image 30 serves as a key to the first 26 and second 28 narratives. In the present invention, a reader can instantly infer—without any reading—the common content of the two different narratives at any point in the story. For instance, the image 30 of a sleeping goblin shows the reader that the simple first narrative 26 and advanced second 28 narrative versions both involve a sleeping goblin. Image 30 provides a non-verbal key that links the content of the first 26 and second 28 narratives together. Without this unique feature, a low-level reader could only guess what parts of the simple narrative can be found in the advanced narrative, and would be decoding the advanced narrative without clear cues. Consider respectively the following first narrative 26 and second narrative 28 versions:
The goblin took off his hat. There was a mouse on his head. The goblin sat down and fell asleep.(simple)
Suddenly tired, the goblin doffed his hat and tossed it to the ground. Creatures often nested in his hair. He sat with his back against a tree and soon drifted into a deep slumber.(advanced)

Without image 30, a low-level reader would explore the advanced narrative blindly—perhaps looking for a reference to a mouse: Does this word “creature” refer to a kind of mouse? Or maybe “slumber” has something to do with thee name of the mouse? Now consider the same page with an image 30 included as in FIG. 3. Image 30 defines the content shared by the simple and advanced narratives. The reader can confidently explore the advanced narrative, looking for references to a sleeping goblin with his hat off: “doffed” must mean “took off”, and “slumber” must mean “sleep”.

FIGS. 4 and 5 are a top plan view of a document cover 40, and a side elevation view of a document spine 42. Cover 40 includes a first title 44 which is associated with the first reading level. Cover also includes a second title 46 which is associated with the second reading level. Cover 40 further includes an image 48 which depicts both first title 44 and second title 46. Image 48 is disposed between first title 44 and second title 46.

The teachings of the present invention can also be applied to page stations 24 on a single side of one page, and which are not part of a document 22 having a plurality of pages (for example page 4 of FIG. 1 as a standalone page). As such, a format for presenting information includes a page station 24 which includes a first narrative 26 written at a first reading level, and a second narrative 28 written at a second reading level, said second reading level higher than said first reading level. Page station 24 also includes an image 30 which depicts both first narrative 26 and second narrative 28.

In terms of use, a method for a reader to read a story includes: (refer to FIGS. 1-3)

(a) providing a format 20 for presenting a story including:
a document 22 having a plurality of page stations 24;
each page station 24 including a first narrative 26 written at a first reading level, and a second narrative 28 written at a second reading level, wherein the second reading level higher than the first reading level;
each page station 24 including an image 30, image 30 depicting both first narrative 26 and second narrative 28; and,

(b) the reader looking at image 30 of a page station 24 and reading at least one of first narrative 26 and second narrative 28.

The method further including:

in step (b), the reader looking at image 30 and reading first narrative 26;

the reader then reading second narrative 28; and,

if in reading second narrative 28 the reader encounters an unknown word or phase, with image 30 in mind, the reader attempting to associate the unknown word or phrase with a known word or phrase in first narrative 26.

The method further including:

in step (b), the reader looking at image 30 and reading second narrative 28; and,

if in reading second narrative 28 the reader encounters an unknown word or phase, with image 30 in mind, the reader attempting to associate the unknown word or phrase with a known word or phrase in first narrative 26.

The method further including:

in step (b), the reader sequentially reading all the page stations 24 of the document 22 by looking at images 30 and reading the first narratives 26 of all the page stations 24.

The method further including:

in step (b), the reader sequentially reading all the page stations 24 of the document 22 by looking at images 30 and reading the second narratives 26 of all the page stations 24.

The preferred embodiments of the invention described herein are exemplary and numerous modifications, variations, and rearrangements can be readily envisioned to achieve an equivalent result, all of which are intended to be embraced within the scope of the appended claims.

I claim:

1. A format for presenting a story, comprising:
a document having a plurality of page stations;
each said page station including a first narrative written at a first reading level, and a second narrative written at a second reading level, said second reading level higher than said first reading level; and,
each said page station including an image, said image depicting both said first narrative and said second narrative.

2. The format according to claim 1, further including:
said image depicting narrative content which is shared by said first narrative and said second narrative.

3. The format according to claim 1, further including:
said image providing a key to content of both said first narrative and said second narrative.

4. The format according to claim 1, further including:
said first narrative and said second narrative presenting the same part of the story in parallel fashion.

5. The format according to claim 1, further including:
said first narrative of all said page stations sequentially telling the story; and,
said second narrative of all said page stations sequentially telling the same story.

6. The format according to claim 1, further including:
said first narrative, said second narrative, and said image being simultaneously visible.

7. The format according to claim 1, further including:
said first narrative, said second narrative, and said image all being disposed on a single side of one page.

8. The format according to claim 7, further including:
said image being disposed between said first narrative and said second narrative.

9. The format according to Clam 1, further including:
said first narrative and said second narrative being disposed on a single side of one page, and said image being disposed on a facing side of an adjacent page.

10. The format according to claim 1, further including:
said document having a cover;
said cover including a first title associated with said first reading level;
said cover including a second title associated with said second reading level;
said cover including an image which depicts both said first title and said second title; and,
said image disposed between said first title and said second title.

11. The format according to claim 1, further including:
said image depicting narrative content which is shared by said first narrative and said second narrative;
said image providing a key to content of both said first narrative and said second narrative;
said first narrative and said second narrative presenting the same part of the story in parallel fashion;
said first narrative of all said page stations page stations sequentially telling the story;
said second narrative of all said page stations sequentially telling the same story; and,
said first narrative, said second narrative, and said image being simultaneously visible.

12. A method for a reader to read a story, comprising:
(a) providing a format for presenting a story including:
a document having a plurality of page stations;
each said page station including a first narrative written at a first reading level, and a second narrative written at a second reading level, said second reading level higher than said first reading level;
each said page station including an image, said image depicting both said first narrative and said second narrative; and,
(b) the reader looking at a said image of a said page station and reading at least one of said first narrative and said second narrative.

13. The method of claim 12, further including:
in step (b), the reader looking at said image and reading said first narrative;
the reader then reading said second narrative; and,
if in reading said second narrative the reader encounters an unknown word or phase, with said image in mind, the reader attempting to associate said unknown word or phrase with a known word or phrase in said first narrative.

14. The method of claim 12, further including:
in step (b), the reader looking at said image and reading said second narrative; and,
if in reading said second narrative the reader encounters an unknown word or phase, with said image in mind, the reader attempting to associate said unknown word or phrase with a known word or phrase in said first narrative.

15. The method of claim 12, further including:
in step (b), the reader sequentially reading all said page stations of said document by looking at said images and reading said first narratives of all said page stations.

16. The method of claim 12, further including:
in step (b), the reader sequentially reading all said page stations of said document by looking at said images and reading said second narratives of all said page stations.

17. A format for presenting information, comprising:
a page station;
said page station including a first narrative written at a first reading level, and a second narrative written at a second reading level, said second reading level higher than said first reading level; and,
said page station including an image, said image depicting both said first narrative and said second narrative.
